(19) United States
(12) Patent Application Publication
(10) Pub. No.: US 2026/0370069 A1
(43) Pub. Date: Nov. 19, 2026

(54) ELECTRIC MACHINE HAVING A DIVERTER DEVICE FOR HYDRAULIC MEDIUM FOR END WINDING COOLING IN A LAMINATED CORE OF A STATOR

(71) Applicant: Schaeffler Technologies AG & Co. KG, Herzogenaurach (DE)

(72) Inventors: Aurelien Grauss, Mommenheim (FR); Martin Chambrion, Erstein (FR); Marcell Röll, Ottersweier (DE)

(21) Appl. No.: 19/515,391

(22) PCT Filed: Aug. 16, 2024
(86) PCT No.: PCT/DE2024/100738

§ 371 Date: Feb. 27, 2026

(30) Foreign Application Priority Data
Sep. 1, 2023 (DE) 10 2023 123 592.3
Nov. 10, 2023 (DE) 10 2023 131 214.6

(51) Int. Cl. H02K 1/20; H02K 9/19

(52) U.S. Cl. CPC H02K 1/20; H02K 9/19

(57) ABSTRACT

An electric machine for a motor vehicle includes a stator of overall annular shape, wherein the stator also has a main body consisting of a laminated core and the main body is provided with axially extending, radially inwardly open stator slots and with axial cooling channels positioned radially outside the stator slots and/or circumferentially between the stator slots, wherein a diverter device that has at least one metal sheet or a plastics plate and is designed to divert a hydraulic medium flowing through the cooling channels during operation is attached to an end side of the main body, wherein at least two cooling channels are connected to a common outlet opening of the diverter device.

The invention relates to an electric machine, preferably a drive machine, for a motor vehicle, such as a car, truck, bus or other commercial vehicle, having a stator of overall annular shape, the stator further having a main body consisting of a laminated core and the main body being provided with axially extending, radially inwardly open stator slots and axial cooling channels positioned radially outside the stator slots and/or circumferentially between the stator slots.

Stators of electric machines of the type in question are known, for example, from DE 10 2019 216 134 A1 or US 2022/0200370A1 . In particular, stator designs made of stacked laminations/laminated cores in which cooling channels are incorporated are already well known.

In the already known designs, it has been found that relatively complex housing components have to be provided for a complete cooling of the stator, in particular also of an end winding of a coil winding of the stator arranged on an axial side of the main body. These measures also usually take up a relatively large amount of axial installation space.

It is therefore an object of the present invention to provide a stator that is cooled as efficiently as possible and at the same time has compact dimensions.

This is achieved according to the invention in that a diverter device having at least one metal sheet and designed to divert a hydraulic medium flowing through the cooling channels during operation is attached to an end side of the main body, with at least two cooling channels being connected to a common outlet opening of the diverter device.

By forming the diverter device from a metal sheet, said diverter device is formed on the main body in a manner that saves as much installation space as possible, without significantly increasing the axial installation space of the main body. By combining two hydraulic medium flows from two cooling channels towards an outlet opening, a relatively strong jet is generated during operation, which efficiently cools the end winding.

Further advantageous embodiments are claimed in the dependent claims and explained in more detail below.

Accordingly, it is also advantageous if the diverter device has a plurality of, preferably at least two or at least three, metal sheets which are arranged in a manner axially overlapping or stacked with respect to one another and are fastened to one another. This makes it easy to create a channel structure within the diverter device between the cooling channels and the outlet opening on the output side. In particular, common processes such as punching and/or forming processes can be used to produce the metal sheets. This makes production significantly easier.

In addition, it has proven advantageous if the at least one metal sheet has a coating which is designed in such a way that, during the manufacturing process of the main body, when the main body is heated to a certain temperature, it is directly connected integrally/adhesively to the main body and/or to additional metal sheets. This means that at least one metal sheet is skillfully baked to the main body. Alternatively or additionally, it is advantageous if the at least one metal sheet forms a form-fitting and/or frictional connection to the main body. Preferably, the at least one metal sheet has one or more axially projecting pins which engage in a form-fitting manner in one or more receiving holes of the main body. This provides even more robust support radially and circumferentially for the metal sheet on the main body.

It has also been found to be advantageous if a first metal sheet of the diverter device forms a collecting channel that overlaps two axial channel openings of two cooling channels (and thus directly connects the cooling channels to one another). This ensures that the outlet opening is connected as directly as possible to the cooling channels.

In this regard, it is furthermore expedient if the collecting channel is designed as an axial through-hole, preferably by punching, or as a diverting pocket (as a depression/trough) shaped/flared by forming, preferably by embossing. This results in a production of the diverter device which is as cost-effective as possible.

The collecting channel is preferably designed to be kidney-shaped, U-shaped or V-shaped, which makes it easy to produce.

Furthermore, it is advantageous if the plurality of metal sheets of the diverter device have different material thicknesses/sheet thicknesses. This makes it possible to skillfully adapt the flow cross-section of the cooling channels.

The diverter device is designed even more simply if the collecting channel is connected to the outlet opening formed directly in the first metal sheet or in a second metal sheet connected to the first metal sheet.

Depending on the periphery present, it is advantageous if the outlet opening is oriented exclusively axially, i.e., an orifice region of the outlet opening emerges exclusively axially to the surroundings of the diverter device, or is incorporated in an axially flared diverter region of a metal sheet in such a way that it/the orifice region is at least partially inclined inwardly in a radial direction.

If at least one metal sheet has a constant radial inner diameter, it is particularly easy to produce. The induction fields/magnetic field lines generated in the main body during operation are also influenced as little as possible by the diverter device.

Alternatively, it is also advantageous if the at least one metal sheet per stator tooth of the main body has a radially inwardly projecting support protrusion, which support protrusion bears against the stator tooth of the main body. A stator tooth is formed directly between two adjacent stator slots of the main body. The support protrusion preferably has a smaller dimension than the stator tooth so that it then only slightly influences the generated magnetic field lines. Alternatively, it is also advantageous if the support protrusion has the same shape as the stator tooth and thus overlaps/covers it congruently/completely.

In this regard, it has again proven to be expedient if the at least one metal sheet is provided with a collecting channel and the collecting channel has two radially extending partial regions spaced apart from one another circumferentially and incorporated into different support protrusions, the support protrusions provided with the partial regions being designed with different widths towards the sides of the partial regions. This also ensures that the induction fields/magnetic field lines generated in the main body during operation are influenced as little as possible by the diverter device.

The metal sheet can run continuously circumferentially and thus be of annular shape or alternatively be composed of a plurality of sub-segments, which in turn form an annular structure.

The invention is now be explained in more detail with reference to figures, in which context various embodiments are also shown.

### IN THE DRAWINGS

FIG. 1 shows a perspective view of a longitudinally sectioned stator of an electric machine according to the invention according to a first exemplary embodiment, wherein a diverter device attached to the end side of a main body of the stator is illustrated in the region of a collecting channel, which is connected on the one hand to two cooling channels of a main body and on the other hand to an outlet opening of the diverter device;

FIG. 2 shows a perspective view of a circumferential region of the stator from FIG. 1, illustrating the extension of the diverter device circumferentially and a plurality of outlet openings incorporated therein;

FIG. 3 shows a perspective view of the main body of the stator from FIG. 1, illustrating a plurality of cooling channels incorporated into the main body radially outside stator slots,

FIG. 4 shows a perspective view of a first metal sheet of the diverter device in the region of a collecting channel formed therein;

FIG. 5 shows a perspective view of a circumferential region of a stator of an electric machine according to the invention according to a second exemplary embodiment, which differs from the first embodiment in particular in that the metal sheets of the diverter device are now provided with support protrusions, each of which covers a stator tooth of the stator;

FIG. 6 shows a perspective view of a circumferential region of a stator of an electric machine according to the invention according to a third exemplary embodiment, the diverter device being formed by a single metal sheet and the collecting channels shaped therein being formed by pronounced diverting pockets;

FIG. 7 shows a perspective view of a stator of an electric machine according to the invention according to a fourth exemplary embodiment, which is implemented similarly to the exemplary embodiment of FIG. 6, the outlet openings of the diverter device being also oriented radially inwards;

FIG. 8 shows a perspective view of the metal sheet used in FIG. 7 in the region of a diverting pocket to an inner side facing the main body, wherein at the same time a flow of the hydraulic medium taking place during operation can be seen;

FIG. 9 shows a perspective view of a circumferential region of a stator of an electric machine according to the invention according to a fifth exemplary embodiment, which differs from the first exemplary embodiment in particular in that the outlet openings are arranged in a partially formed region and are thus also oriented in a radial direction;

FIG. 10 shows a perspective view of a collecting channel incorporated in a first metal sheet of FIG. 9, again illustrating the hydraulic medium flow taking place during operation;

FIG. 11 shows a perspective view of a stator of a stator of an electric machine according to the invention according to a sixth exemplary embodiment, wherein the diverter device is composed of arc-segment-shaped components;

FIG. 12 shows a perspective view of a metal sheet according to a stator of an electric machine according to the invention according to a seventh exemplary embodiment, wherein a pin for fixing the metal sheet to the main body can be seen;

FIG. 13 shows a perspective view of a circumferential region of a stator of an electric machine according to the invention according to an eighth exemplary embodiment, wherein it can be seen that the metal sheets of the diverter device have different sheet thicknesses;

FIG. 14 shows a perspective view of the stator with the second metal sheet of the diverter device so that U-shaped collecting channels of a first metal sheet of the diverter are clearly visible;

FIG. 15 shows a perspective view of the main body of the stator according to FIG. 13; and

FIG. 16 shows a plan view of the first metal sheet used in FIGS. 13 to 15, wherein distances between partial regions of the U-shaped collecting channel and the edges of the support protrusions/stator teeth are marked.

The figures are merely schematic in nature and serve solely to assist in understanding the invention. Identical elements are provided with the same reference signs. The features of the various exemplary embodiments can in principle also be freely combined with one another.

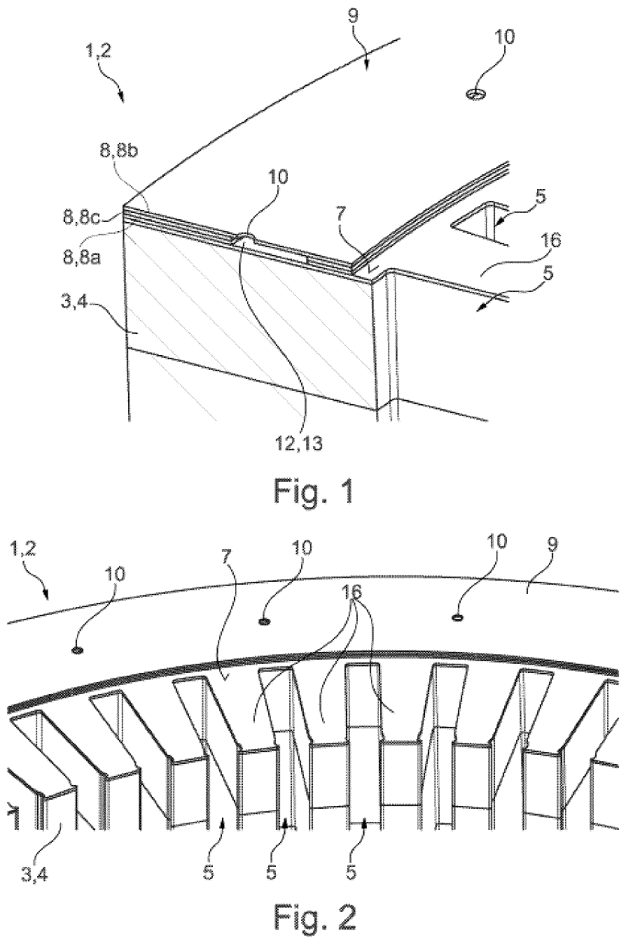

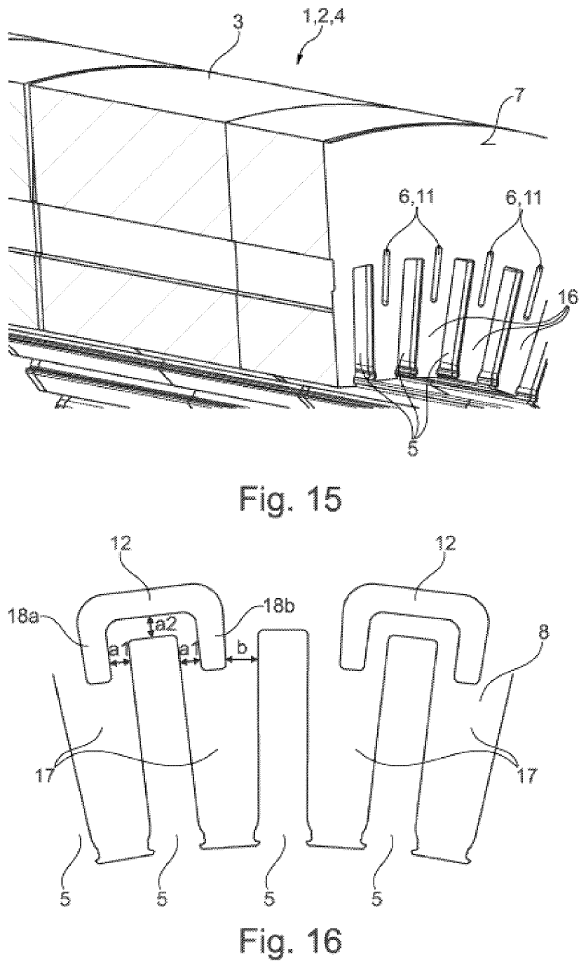

The invention relates to an electric machine 1, as is preferably used for driving a motor vehicle. For the sake of clarity, FIGS. 1 to 16 only show the stator 2 of the electric machine 1, which is of overall annular shape.

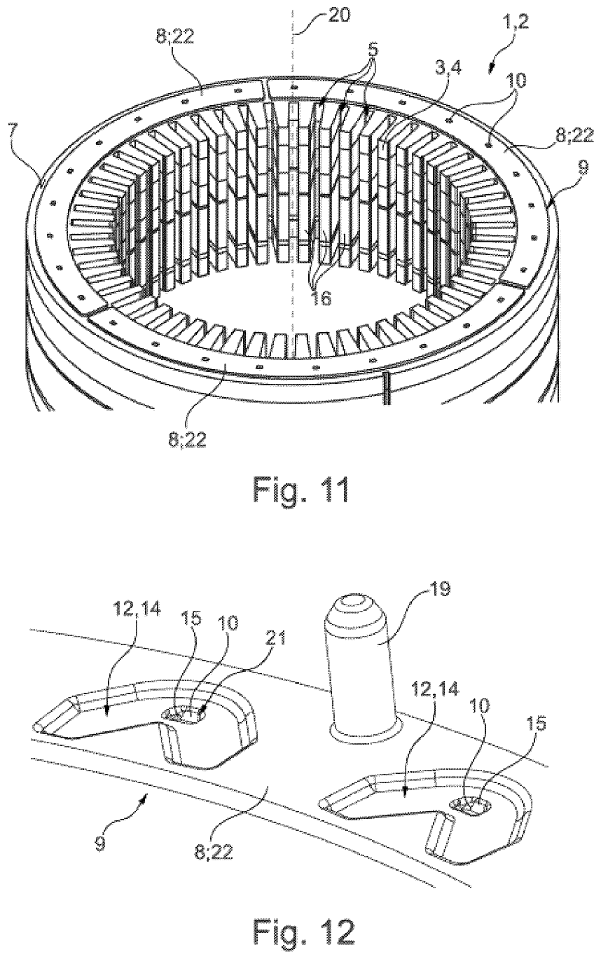

With the exemplary embodiment of FIG. 11, the stator 2 can be seen from its main body 4. The main body 4 is formed in turn from a laminated core 3. The laminated core 3 is composed of a large number of axially stacked individual laminations designed as identical parts.

A plurality of stator slots 5 distributed circumferentially are formed in the stator 2/the main body 4, wherein said stator slots extend over the entire length of the stator 2. The stator slots 5 of the main body 4 are open radially inwards, but can in principle be closed during operation after a coil winding of the stator 2 has been incorporated. The stator slots 5 are each delimited from one another circumferentially by stator teeth 16 of the main body 4 which project radially inwards.

On the basis of FIG. 11, to complete the stator 2, further coil windings, not shown here for the sake of clarity, are incorporated in the usual way, which extend through the stator slots 5. In the usual way, the coil winding then projects from the main body 4 to both axial sides over a certain distance and is deflected in these regions, forming an end winding on each side.

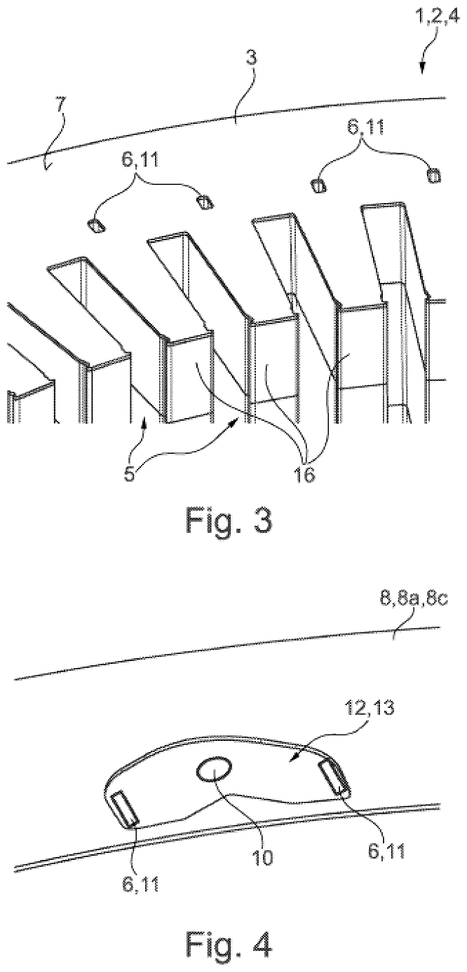

With reference to the first exemplary embodiment of FIGS. 1 to 4, a plurality of cooling channels 6 penetrating the main body 4 in an axial direction can be seen in FIG. 3 for cooling the stator 2. In this embodiment, a cooling channel 6 is provided for each stator tooth 16, which are incorporated radially outside the stator slots 5 in the main body 4. According to the invention, a diverter device 9 on the main body 4 according to the invention is attached to the main body 4 axially, that is to say to an end side 7 of the main body 4. This diverter device 9 according to the invention is formed entirely from metal sheets 8; 8a, 8b, 8c, in the first exemplary embodiment by three metal sheets 8; 8a, 8b, 8c. The metal sheets 8; 8a, 8b, 8c are designed as electrical steel sheets and are preferably provided with a special coating before being connected to the main body 4. During the production of the main body 4, the metal sheets 8; 8a, 8b, 8c are directly connected to one another and to the main body 4 by this coating, i.e., they are heated and connected integrally/adhesively.

In this context, it should be noted that it is in principle also possible to provide additional fastening means, such as form-fitting or frictional fastening means. As can be seen in the exemplary embodiment of FIG. 12, it is possible, for example, to attach an axially projecting pin 19 to a metal sheet 8, which is inserted into an opposite receiving opening of the main body 4 and thus serves for radial and circumferential support.

For the sake of completeness, it should be noted that the directional specifications used representationally, namely axial/axial direction, radial/radial direction and circumferentially/circumferential direction, should be understood in relation to a central longitudinal axis 20 of stator 2, as shown in FIG. 11. A longitudinal axis 20 is understood to be an axis of rotation of a rotor of the electric machine 1 which is rotatably mounted within the stator 2 during operation. Axial/axial direction is therefore to be understood as a direction along/parallel to the longitudinal axis 20; radial/radial direction is to be understood as a direction perpendicular to the longitudinal axis 20; and a circumferential direction is to be understood as a direction along a circular line that runs coaxially around the longitudinal axis 20.

In the first exemplary embodiment of FIGS. 1 to 4, a first metal sheet 8a of the diverter device 9, which is attached to/bears against the main body 4 directly, has the collecting channel 12 shown in FIG. 4. The collecting channel 12 is substantially kidney-shaped. The collecting channel 12 is formed as an axial through-hole 13 of the first metal sheet 8a. The collecting channel 12 is connected, on the one hand, to two cooling channels 6 at the same time. On the other hand, the collecting channel 12 is connected to a common outlet opening 10 of the diverter device 9. The outlet opening 10 is then incorporated in a second metal sheet 8b of the diverter device 9 and can be seen in FIGS. 1 and 2. Thus, each collecting channel 12 is connected to two cooling channels 6, namely two axial channel openings 11 of two cooling channels 6, and connects these to a common single outlet opening 10, which is oriented here as a simple axial bore.

In this embodiment, a third metal sheet 8c is also present in the diverter device 9, which is designed in the same way as the first metal sheet 8a. The first metal sheet 8a and the third metal sheet 8c lie directly on top of one another; and the second metal sheet 8b in turn lies directly on the third metal sheet 8c. In this regard, it should be noted that it is also possible to provide a different number of metal sheets 8. As can be seen in the following exemplary embodiments, the diverter device 9 can also be equipped with only one or two metal sheets 8.

The hydraulic medium flowing out of two cooling channels 6 during operation is thus combined by the collecting channel 12 and is finally passed axially out of the common outlet opening 10 to the surroundings. Since, in an assembled state of the stator 2, the end winding directly axially adjoins the outlet opening 10, the outlet opening 10 also serves to flow around/spray the end winding and thus cool it.

Finally, FIG. 2 shows that the diverter device 9 is of overall annular shape. Preferably, the diverter device 9 extends continuously so that the metal sheets 8; 8a, 8b, 8c are also each implemented as one-piece rings. In this regard, however, it is also possible, as shown in the exemplary embodiment of FIG. 11, to assemble the diverter device 9 from a plurality of arcuate segments, which together form an annular structure. In this case, there are three annular segments, each of which has the structure of the diverter device 9 with a plurality of (also arc-segment-shaped) metal sheets 8.

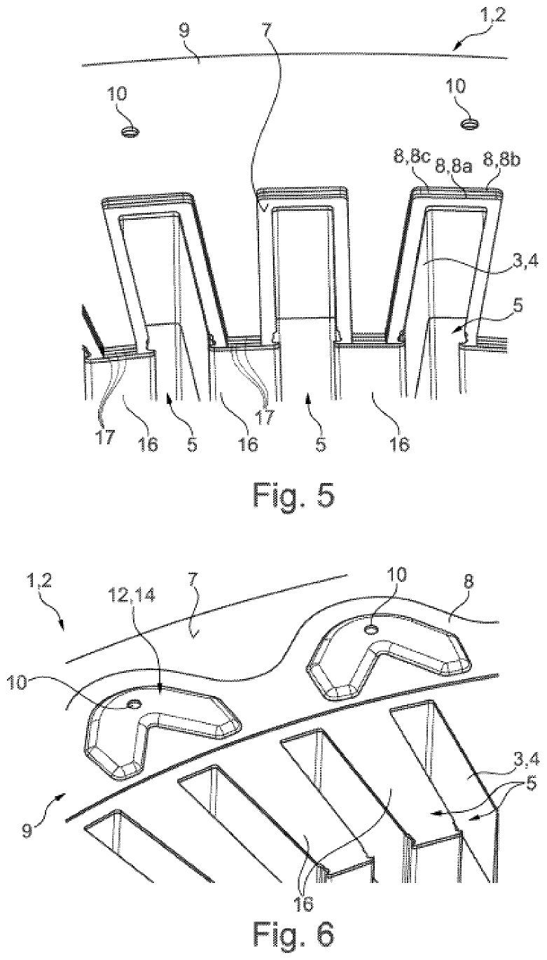

In FIG. 5 it can further be seen that the diverter device 9 and thus the metal sheets 8a, 8b, 8c do not necessarily have to have a constant radial inner diameter, as implemented in the first exemplary embodiment. The metal sheets 8a, 8b, 8c can also each have a plurality of radially projecting support protrusions 17. The support protrusions 17 are arranged at the same circumferential positions as the stator teeth 16 and are arranged congruently with the stator teeth 16. For each stator tooth 16, a support protrusion 17 is provided for each metal sheet 8a, 8b, 8c. The support protrusions 17 of the metal sheets 8a, 8b, 8c, which are each associated with a stator tooth 16, are arranged congruently with respect to one another and have the same dimensions. The support protrusions 17 of the metal sheets 8a, 8b, 8c which are associated with a stator tooth 16 lie (circumferentially) centrally on the stator tooth 16.

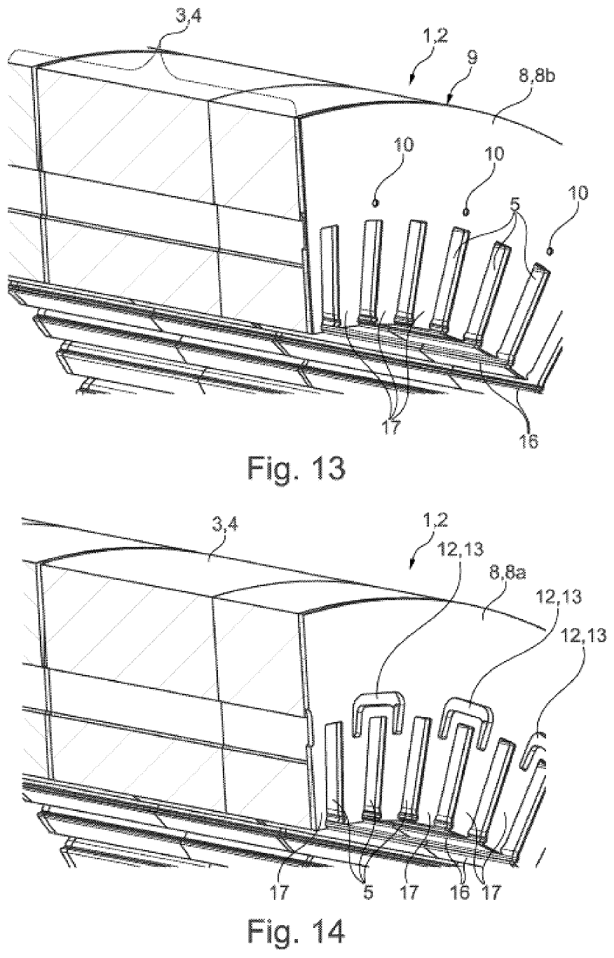

In this regard, it should also be noted that, according to the exemplary embodiment of FIGS. 13 to 15, it is also possible in principle to design the support protrusions 17 in the same way as the stator teeth 16 (in cross-section).

In FIG. 6, the diverter device 9 has only a single metal sheet 8, which directly forms the collecting channels 12 in the form of diverting pockets 14 which are flared by embossing. The collecting channels 12 are each kidney-shaped or V-shaped. Thus, it is in principle also possible to use a single metal sheet 8 and to omit the punched design of the collecting channel 12 implemented in the first exemplary embodiment of FIGS. 1 to 4.

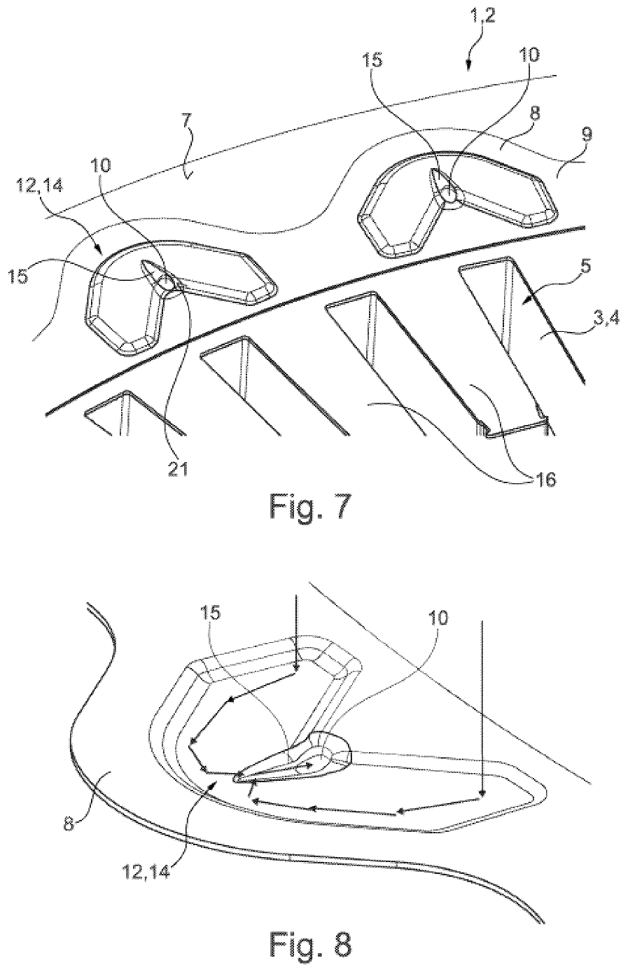

FIGS. 7 and 8 further illustrate an exemplary embodiment in which the outlet opening 10 is arranged on a locally flared raised region 15 of the metal sheet 8, namely circumferentially centrally on the diverting pocket 14. The outlet opening 10 is specifically attached to a radially inclined wall/flank 21 of the raised region 15, so that it also has a specific orientation radially inwards.

FIG. 8 shows a flow of the hydraulic medium, taking place during operation, from the cooling channels 6 into the collecting channel 12 and its deflection towards the common outlet opening 10.

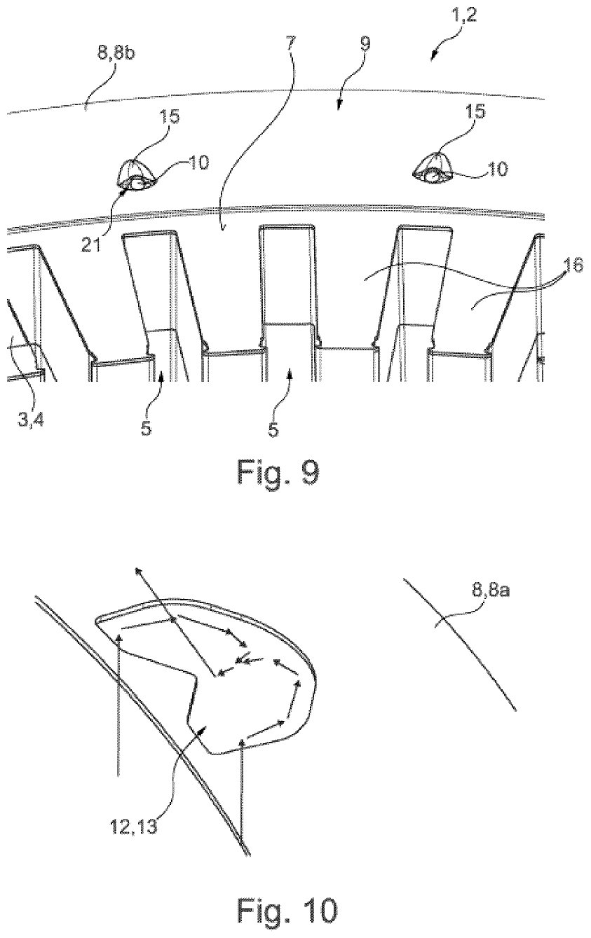

In the exemplary embodiment of FIGS. 9 and 10, it can again be seen that, on the basis of the first exemplary embodiment, it is also possible to radially obliquely position the outlet openings 10 in the second metal sheet by means of local raised regions 15.

In the exemplary embodiment of FIG. 12, the pin 19 is present on an inner side of the metal sheet 8 facing the main body 4 in the assembled state. According to this exemplary embodiment, the diverter device 9 in turn preferably has only a single metal sheet 8.

With regard to the two FIGS. 11 and 12, it should also be noted that these preferably have a plastics plate 22 instead of the metal sheet 8. This allows the pins 19 from FIG. 12 to be formed as easily as possible.

In the exemplary embodiment of FIGS. 13 to 16, it can be seen that the cooling channels 6 can also extend radially between the stator slots 5 of the main body 4, i.e., into the stator tooth 16. The cooling channels 6 are thus each designed elongated in a radial direction.

The collecting channel 12, now extending in a U-shape, extends with its two circumferentially spaced partial regions 18a, 18b, each forming a leg of the U, into the support protrusion 17/the stator tooth 16. It is advantageous if the partial region 18a, 18b of the collecting channel 12 extending in a radial direction has a smaller distance a1 from an inner side of the U (on the side of a stator slot 5 enclosed by the U) to a circumferential edge/side flank of the stator tooth 16/support protrusion 17 than from an outer side (distance b). A radial distance a2 between a bottom of the stator slot 5 and the circumferentially extending region of the U can in turn be greater than or equal to a1 and smaller than b.

In other words, FIGS. 1 to 4 show the first embodiment of the solution according to the invention. Intermediate laminations (first and third metal sheets 8a, 8c) are applied, which have a recess (collecting channel 12) to form channels or intermediate chambers. A cover lamination (second metal sheet 8b) is applied to the last intermediate lamination and has an opening (outlet opening 10), which serves as an outlet for end winding cooling. In this case, two intermediate laminations were stacked on top of each other, with it being conceivable to apply only one or more to the laminated core 3. Laminations of different thicknesses can also be baked together. In the case of a plurality of intermediate laminations, the cooling channel created by the recess in the intermediate lamination 6 must be designed larger or smaller accordingly. The metal sheets 8 were designed in this case as electrical steel sheets, so they are delivered pre-coated so that they can be easily baked. Ideally, they are baked together in the same way during the bonding varnish process of the laminated core 3. If the bonding varnish process is carried out within one step, then a multi-stage tool is necessary to apply a full-area surface pressure to the laminated core 3 before the bonding varnish process. It is also conceivable to produce the laminations from a structural steel, which is coated so that it can be baked to the laminated core 3. Another option in this case is to adhesively bond the laminations. In this embodiment, the laminations can be centered on the outer and/or inner diameter, with the laminated core preferably being centered on the inner diameter. If the laminations need to be centered on the inner diameter, they should preferably be centered using the multi-stage tool. Depending on the assembly sequence, segmentation can be advantageous in order to be able to assemble the laminations.

To explain the concept, FIGS. 3 and 4 show the intermediate lamination with the recess, which serves as a channel and fluidically connects the two channels of the laminated core 3, and the laminated core end lamination, which has the various outlets from the cooling channels 6 in the laminated core 3. It is worth emphasizing here that the laminations preferably do not perform any electromagnetic function. Although these can be made of a magnetic material suitable for stator laminations, they preferably do not have any teeth and therefore do not count towards the active length of the electric machine. Alternatively, the laminations can also be part of the active length of the electric machine. In particular in the embodiment of FIGS. 13 and 14, the lamination tooth of the laminations (stator tooth 16 with support protrusions 17) corresponds exactly to the tooth of the laminated core, so that the solution belongs to the active length. The sealing of the intermediate channels is ensured by the bonding varnish and/or adhesive process.

A second embodiment is shown in FIG. 5. This corresponds to the first embodiment, except that it has smaller teeth than the teeth of the laminated core 3. This allows full-area preload to be applied before the bonding varnish process without a multi-stage tool, but since the teeth are smaller, they are preferably not counted towards the active length of the electric machine. Alternatively, as already mentioned, these can also be added to the active length. An additional advantage of the smaller teeth is that the clearance and creepage distances are not affected. Depending on the requirements of the bonding varnish process, a multi-stage tool, which leads to larger tolerances and thus a low bonding varnish strength, can be dispensed with. In principle, the same alternatives exist as before (electrical steel sheets possibly of different thicknesses, structural steel; bonding varnish in 1 or 2 steps, segmentation, bonding varnish or adhesive bonding).

FIG. 6 shows the third embodiment, in which the inventive solution consists of only one embossed cover lamination (metal sheet 8) instead of stacking a plurality of laminations on top of each other. The embossed portion on the cover lamination was designed such that both openings from the laminated core 3 are fluidically connected by an embossed chamber. In this case, the lamination again has an opening for the outlet for end winding cooling. In this case, the lamination can also optionally be designed as in the first embodiments: a bonding varnish process in 1 or 2 steps, centering on the inner or outer diameter, centering by the (multi-stage) tool from the baking varnish process, adhesive bonding, with and without small inner teeth for full-area application of force without a multi-stage tool, different thickness compared to the previous laminated core.

FIGS. 7 and 8 show another embodiment. This is largely the same as the third embodiment, except that it has an additional embossed portion on the opening so that the oil is deflected as desired to optimally cool the end winding.

Another design can be derived from the previous embodiments, which is shown in FIGS. 9 and 10. This corresponds to the first and second embodiments, in which one or more intermediate laminations were attached, the cover plate here having an additional embossed portion so that the oil is deflected as desired in order to optimally cool the end winding.

Furthermore, a plastic variant is shown in FIGS. 11 and 12. This was designed in segments, and, depending on the assembly sequence and type of fastening, it is possible to provide an annular geometry (similar to the other embodiments). The oil guide ring is pressed into the existing laminated core. For this purpose, the laminated core has bores and the oil guide ring 8 has integrated press-in pins (pins 19) that are distributed around the circumference. The sealing of the intermediate channels can be ensured by different solutions depending on sealing tightness requirements. If further improved sealing tightness is required, a seal made of an elastomer can be provided. If small leakage is permitted, a seal can be omitted. A small gap between the oil guide ring and the laminated core 3 is preferably sufficient to sufficiently reduce the resulting leakage. An adhesive bond that may be leaky depending on requirements could also be accepted.

### LIST OF REFERENCE SIGNS

1 Electric machine
2 Stator
3 Laminated core
4 Main body
5 Stator slot
6 Cooling channel
7 End side
8 Metal sheet
8a First metal sheet
8b Second metal sheet
8c Third metal sheet
9 Diverter device
10 Outlet opening
11 Channel opening
12 Collecting channel
13 Through-hole
14 Diverting pocket
15 Raised region
16 Stator tooth
17 Support protrusion
18a First partial region
18b Second partial region
19 Pins
20 Longitudinal axis
21 Flank
22 Plastics plate

1. An electric machine for a motor vehicle comprising:
a stator of annular shape, wherein the stator has a main body comprising a laminated core, wherein the main body is provided with axially extending, radially inwardly open stator slots and axial cooling channels positioned radially outside the stator slots or circumferentially between the stator slots; and
a diverter device attached to an end side of the main body, the diverter device comprising at least one of a metal sheet or a plastic plate and designed to divert a hydraulic medium flowing through the cooling channels during operation, at least two cooling channels being connected to a common outlet opening of the diverter device.

2. The machine according to claim 1, wherein the diverter device a plurality of metal sheets arranged axially overlapping one another and are fastened to one another.

3. The machine according to claim 2, wherein a first metal sheet of the diverter device forms a collecting channel overlapping two axial channel openings of two cooling channels.

4. The machine according to claim 3, wherein the collecting channel is designed as an axial through-hole or a diverting pocket.

5. The machine according to claim 3, wherein the collecting channel extends in at least one of a kidney-shaped, U-shaped or V-shaped manner.

6. The machine according to claim 3, wherein the collecting channel is connected to the outlet opening formed in the first metal sheet or in a second metal sheet connected to the first metal sheet.

7. The machine according to claim 1, wherein the outlet opening is oriented axially or is incorporated in an axially flared raised region of a metal sheet in such a way that it is at least partially inclined inwardly in a radial direction.

8. The machine according to claim 1, wherein the metal sheet has a constant radial inner diameter.

9. The machine according to claim 1, wherein the metal sheet has a radially inwardly projecting support protrusion for each stator tooth of the main body, wherein the support protrusion bears against the stator tooth of the main body.

10. The machine according to claim 9, wherein the metal sheet includes a collecting channel and the collecting channel has two radially extending partial regions spaced apart from one another circumferentially and incorporated into different support protrusions, the support protrusions including the two radially extending partial regions having different widths towards sides of the two radially extending partial regions.

11. An electric machine for a motor vehicle comprising:
a stator of annular shape, wherein the stator has a main body consisting of a laminated core, wherein the main body is provided with one or more axially extending, radially inwardly open stator slots and one or more axial cooling channels positioned at least radially outside the one or more stator slots or circumferentially between the one or more stator slots;
a diverter device attached to an end side of the main body of the stator, wherein the diverter device includes a plurality of metal sheets arranged axially overlapping and fastened to one another, wherein a first metal sheet of the diverter device forms a collecting channel overlapping two axial channel openings of two cooling channels, wherein the diverter device is designed to divert a hydraulic medium flowing through the one or more axial cooling channels during operation, wherein at least two of the one or more axial cooling channels are connected to a common outlet opening of the diverter device; and
a collecting channel overlapping two axial channel openings of at least two of the one or more axial cooling channels, wherein a first metal sheet of the plurality of metal sheets of the diverter device forms the collecting channel.

13. A vehicle comprising:
an electric machine, the electric machine comprising:
a stator of overall annular shape, wherein the stator has a main body a laminated core, wherein the main body is provided with axially extending, radially inwardly open stator slots and axial cooling channels positioned radially outside the stator slots or circumferentially between the stator slots; and
a diverter device attached to an end side of the main body, the diverter device comprising at least one of a metal sheet or a plastic plate and designed to divert a hydraulic medium flowing through the cooling channels during operation, at least two cooling channels being connected to a common outlet opening of the diverter device.

14. The machine according to claim 13, wherein the diverter device comprises a plurality of metal sheets arranged axially overlapping one another and are fastened to one another.

15. The machine according to claim 14, wherein a first metal sheet of the diverter device forms a collecting channel overlapping two axial channel openings of two cooling channels.

16. The machine according to claim 15, wherein the collecting channel is designed as an axial through-hole or a diverting pocket.

17. The machine according to claim 15, wherein the collecting channel is connected to the outlet opening formed in the first metal sheet or in a second metal sheet connected to the first metal sheet.

18. The machine according to claim 13, wherein the outlet opening is oriented axially or is incorporated in an axially flared raised region of a metal sheet in such a way that it is at least partially inclined inwardly in a radial direction.

19. The machine according to claim 13, wherein the metal sheet has a constant radial inner diameter.

20. The machine according to claim 13, wherein the metal sheet has a radially inwardly projecting support protrusion for each stator tooth of the main body, wherein the support protrusion bears against the stator tooth of the main body.
